(19) United States
(12) Patent Application Publication
(10) Pub. No.: US 2015/0193206 A1
(43) Pub. Date: Jul. 9, 2015

(54) METHOD FOR GENERATING AN OUTPUT OF A RANDOM SOURCE OF A RANDOM GENERATOR

(71) Applicant: Robert Bosch GmbH, Stuttgart (DE)

(72) Inventor: Eberhard BOEHL, Reutlingen (DE)

(21) Appl. No.: 14/593,532

(22) Filed: Jan. 9, 2015

(30) Foreign Application Priority Data
Jan. 9, 2014 (DE) 10 2014 200 163.3

(51) Int. Cl. G06F 7/58

(52) U.S. Cl. CPC G06F 7/58

(57) ABSTRACT

A method and a system are presented for generating an output of a random source of a random generator. The random source is sampled using at least one sampling unit, so that an output signal is generated, the output signal being processed by at least two processing units that process differently.

### FIELD OF THE INVENTION

The present invention relates to a method for generating an output of a random source of a random generator, and to a system for carrying out the method.

### BACKGROUND INFORMATION

Random numbers as results or outputs of random sources in random generators are required for many applications. Random generators are methods that supply a sequence of random numbers. A decisive criterion of the quality of random numbers is whether the result of the generation can be regarded as independent of earlier results.

Random numbers are required for example for cryptographic methods, where they are used to generate keys for these encryption methods. Thus, random generators, or random number generators (RNG), are used to generate master keys for symmetrical encryption methods and for protocol handshaking in ECC (elliptical curve cryptography), which prevent a power analysis attack and replay attacks.

There are two fundamental types of random generators; on the one hand there are pseudo-random number generators (PRNG) for high throughput and low security levels. Standardly, a secret value is inputted to a PRNG, and a given input value will always result in the same output sequence. However, a good PRNG will output a number sequence that appears random and that will withstand most tests.

It is to be noted that keys for cryptographic methods are subject to high demands with regard to randomness. Therefore, pseudo-random number generators (PRNG), such as for example an LFRS (linear feedback shift register), are not suitable for this purpose. Only a generator that produces true random numbers, or a true random number generator (TRNG), will meet these requirements. This is the other type of random generator. In this type of generator, natural noise processes are used to obtain an unpredictable result.

Standardly used are noise generators that make use of the thermal noise of resistors or semiconductors, or the shot noise at potential barriers, for example at pn transitions. Another possibility is to make use of the radioactive decay of isotopes.

While the “classical” methods make use of analog elements, such as resistors, as noise sources, more recently digital elements such as inverters have often been used. These have the advantage of lower outlay in the circuit layout, because they are present as standard elements. In addition, such circuits can also be used in freely programmable circuits, such as FPGAs.

Thus, for example the use of ring oscillators is known, which represent an electronic oscillator circuit. In these oscillators, an odd number of inverters are connected together to form a ring, resulting in an oscillation having an inherent frequency. The inherent frequency here is a function of the number of inverters in the ring, the properties of the inverter, and the conditions of the interconnection, namely the line capacitances, operating voltage, and temperature. The noise of the inverters results in a random phase shift relative to the ideal oscillator frequency, which is used as a random process for the TRNG. Here it is to be noted that ring oscillators self-oscillate, and do not require external components such as capacitors or coils.

The output of the ring oscillators can be compressed or can be subjected to post-processing in order to compress the entropy or to concentrate it, i.e. to increase it, and to eliminate any tendency (bias).

Here, a problem is that the ring oscillator has to be sampled as far as possible in the vicinity of an expected ideal edge so that a random sampling value is obtained. On this, the publication by Bock, H., Bucci, M., Luzzi, R.: An Offset-compensated Oscillator-based Random Bit Source for Security Applications, CHES 2005, shows how it is possible for the sampling always to take place in the vicinity of an oscillator edge, through the regulated shifting of the sampling time.

From European Patent No. 1 686 458 B1, a method is known for generating random numbers using a ring oscillator, in which a first and a second signal are provided, the first signal being sampled as a result of triggering by the second signal. In the described method, a ring oscillator is multiply sampled, and here it is always the case that only non-inverting delays, namely an even number of inverters used as delay elements, are used. Here, beginning from a starting point, the oscillator ring is always sampled after an even number of inverters, simultaneously or with a mutual delay. In this way, the shift of the sampling time can be done without; instead, the multiple sampling signals are evaluated.

In the publication Design of Testable Random Bit Generators by Bucci, M., and Luzzi, R. (CHES 2005), a method is presented by which an influencing of the random source can be determined. In this way, attacks can be prevented. However, this does not permit a direct distinction between random values and deterministic values. It is possible to evaluate the quality of the random source by counting the transitions.

A further possibility is to use a plurality of ring oscillators. This is presented for example in the publication by Sunar, B. et al.: Approvable Secure True Random Number Generator with Built In Tolerance Attacks, IEEE Trans. on Computers, January 2007. Here, sampled values of a plurality of ring oscillators are linked to one another and evaluated.

As already stated, in ring oscillators an odd number of inverters are connected together to form a ring, resulting in an oscillation having an inherent frequency. Here, the inherent frequency is a function of the number of inverters in the ring, the properties of the inverters, and the conditions of the interconnection, i.e. of the line capacitances, the operating voltage, and the temperature. The noise of the inverters results in a random phase shift relative to the ideal oscillator frequency, which is used as a random process for the TRNG.

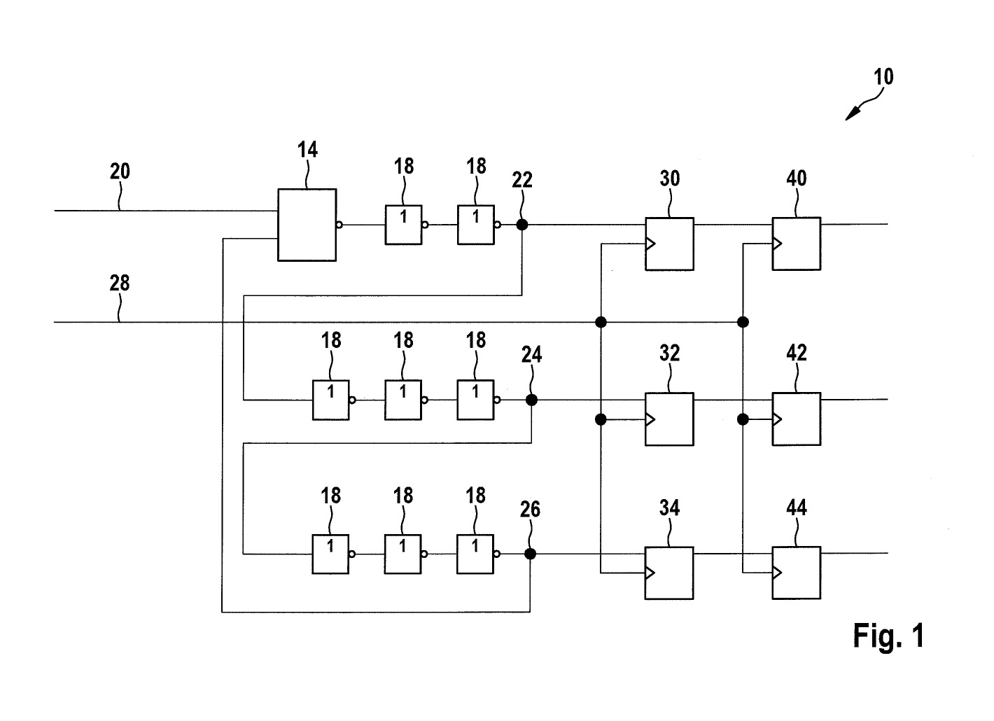

An advantageous realization of a TRNG source using a ring oscillator sampled at a plurality of points is shown in FIG. 1. This circuit at the same time offers the advantage that a correlation to the system clock can be determined and errors can be discovered if particular realization conditions are present with a uniform capacitive loading of all nodes of the ring oscillator, and the circuit elements used, such as for example flip-flops and inverters, are designed in such a way that they react as uniformly as possible to rising and falling edges.

German Published Patent Application No. 60 2004 011 081 T2 describes how to test a TRNG source after a post-processing, and how to put this post-processing into a certification mode for this purpose.

### SUMMARY

Against this background, a method is presented , and a system is presented.

Thus, a method is presented whose design is based on a compression method for post-processing of an output of a random source of a random generator. In this compression method forming the basis, the random source outputs a digital output signal having a bit width of at least one bit, and the output signal is compressed. Here, in the context of the compression, a block-by-block linear linkage of n successive bits of the output signal is carried out, where n is a compression factor, and this produces a compressed output signal that includes a sequence of compressed signal values. The sequence of compressed signal values can be checked with regard to their distribution.

In this compression method, in an embodiment it can be provided that the bits of the output signal are either linked to one another directly through a linear operation, and this combined signal is compressed serially through a linear operation, or compression first takes place in bit-by-bit fashion and the compressed values are subsequently subjected to a further processing, for example are linked in linear fashion. Here, a first post-processing step and a second post-processing step can be provided, a linear linkage being carried out in at least one of the two, e.g. with an XOR element or an XNOR element.

All previous methods that use exclusively digital elements as entropy sources, for example an odd number of inverters connected to form a ring, require in part very expensive post-processing circuits that on the one hand enrich the entropy and on the other hand ensure a uniform distribution of the random bits between the values 0 and 1. The presented compression method offers a simple possibility for post-processing. In particular, the complex post-processing, having a certification mode, described in DE 60 2004 011 081 T2 can be omitted.

According to the presented compression method, a TRNG source can be used having a plurality of outputs, each of these outputs being equipped with a simple compression function, for example a serial XOR. The outlay of such a method is low enough that a TRNG can be realized having approximately 200 gate equivalents. This is significantly more advantageous than is the case in known methods.

A block-by-block linear linkage can be achieved for example through a serial XOR, where for example the output signal is linked in linear fashion to an intermediate signal through XOR. A linkage using XNOR is also possible. Here, the result of this linkage is stored in a storage element, such as a flip-flop. The output signal of this storage element is the intermediate signal. The compressed signal formed in this way in the storage element is read out after a specified number n of clock pulses. Subsequently, the storage element is reset. The number n should if possible be odd, because n zeros and n ones then supply different results.

The checking of the distribution can be carried out for example by counting the occurrence of the bit value 0 and the bit value 1 in separate counters for m compressed output bits, and by carrying out the comparison through difference formation of these count values, and comparing the difference to a specified limit.

If a ring oscillator is used as random source, its frequency can be influenced through the selection of the number of inverting elements, or also through the modification of the operating conditions, such as operating voltage, temperature, etc. The number of inverting elements in the ring oscillator can be modified as follows:

a) generic approach in the synthesis with a variable number of inverting elements. However, this can only be carried out in a FPGA after a new synthesis.

b) structure of the ring oscillator provided with inverting elements that can be partially bridged, controlled by a control signal. This additional circuit amplifies the unequal capacitances of the nodes in the ring oscillator. However, this is not disadvantageous if variation takes place corresponding to the compression factor and/or the sampling frequency.

Modifications of the operating conditions can be carried out as follows:

a) by a separately controllable supply voltage that is explicitly led out, or by series resistors in the supply to the ring oscillator (voltage drop),

b) by heating or cooling elements that are optionally connected.

A mutual comparison of the number of zeros and ones means for example that the largest and smallest number of an occupancy are determined through a larger/smaller comparison, e.g.

a) by checking whether a difference becomes negative, or

b) by comparing the counter values bit-by-bit, beginning from the MSB; at the first deviation at a bit position the value having a 1 at this position is greater than the other;

and then forming the difference of the largest and smallest value, which is in turn compared to a fixed limit.

Thus, a compression method is used in which the uniform distribution between 0 and 1 is achieved through a simple compression using XOR linkage. The non-uniform distribution, referred to as “bias,” is achieved through a corresponding degree of compression in connection with a suitable selection of the sampling frequency.

Using a suitable testing method, it can be determined whether the bias is sufficiently small or whether, due to a correlation of the oscillator with an internal or external clock, no sufficiently large random value can be achieved.

In addition, a method is presented in which a random source is sampled multiple times. If the random source is a ring oscillator, then the frequency of the oscillator is reduced through this additional loading. In this way, less randomness is available. If the sampling is carried out at the same location, this loading increased at one side additionally increases the distortion. This has to be compensated by higher compression, which in turn somewhat reduces the data rate.

The compression method has the disadvantage that the achievable bit rate of the TRNG is less than would be possible corresponding to the available entropy. This is caused by the fact that with simple XOR compression the bias is removed by high compression, but on the other hand this high compression destroys entropy. This is described in the publication by Markus Dichtl (Siemens AG): Bad and Good Ways of Post-Processing Biased Physical Random Numbers: see Biryukov. A. (ed.), FSE 2007, LNC, vol. 4593, pp. 127-152, Springer, Heidelberg 2007.

A method is now proposed in which a sampling is carried out at a plurality of sampling points, but the sampling values are differently processed.

In contrast to the method in which the random source is multiply sampled, intervention does not take place in the random source, e.g. the ring oscillator. As a result, there is no change in the frequency or in the distortion of the oscillator, which causes a lower data rate.

Thus, the same random source, e.g. the same ring oscillator, can be used with the same sampling elements, e.g. flip-flops. Here, the entropy present in the raw sampling data can be used for at least two compressions with different compression factors, and in this way the bit rate is increased in a simple manner. Through a suitable selection of the compression factors relative to one another, e.g. relatively prime or prime numbers, and the estimation of the present (least) entropy, it can be ensured that the two compressions are not functionally related, so that the bits of the two compressions can enter into a random value for which each bit has the full entropy. The data rate is higher than in the methods described above.

Further advantages and embodiments of the present invention result from the description and from the accompanying drawings.

Of course, the features named above and explained below can be used not only in the respectively indicated combination, but also in other combinations or by themselves, without departing from the scope of the present invention.

### BRIEF DESCRIPTION OF THE INVENTION

FIG. 1 shows an embodiment of a ring oscillator.

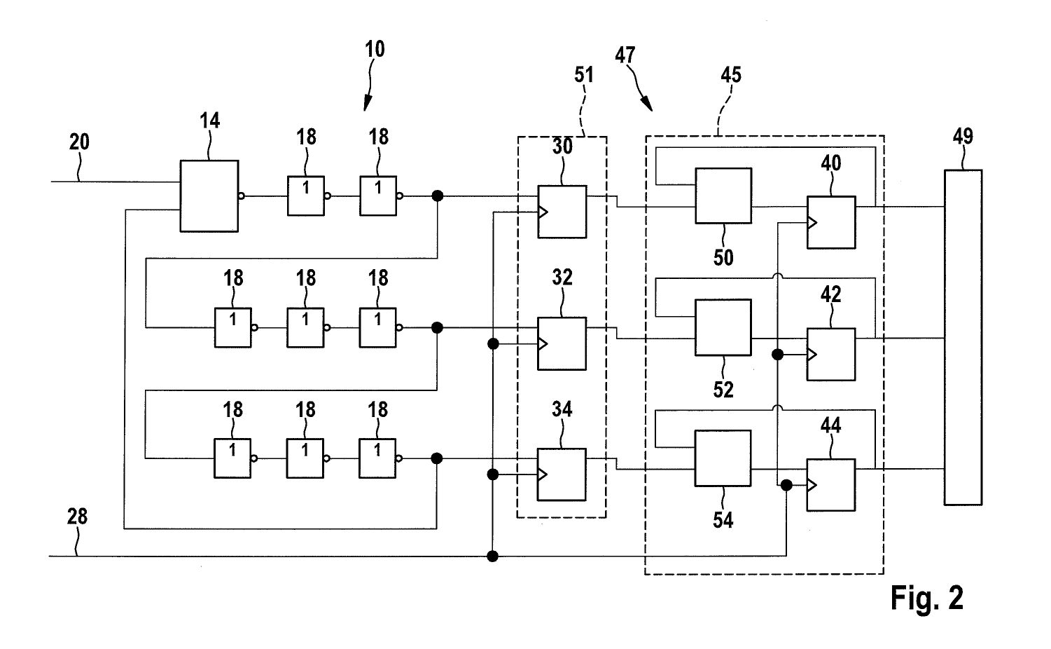

FIG. 2 shows a system for compressing an output of a ring oscillator together with the ring oscillator of FIG. 1.

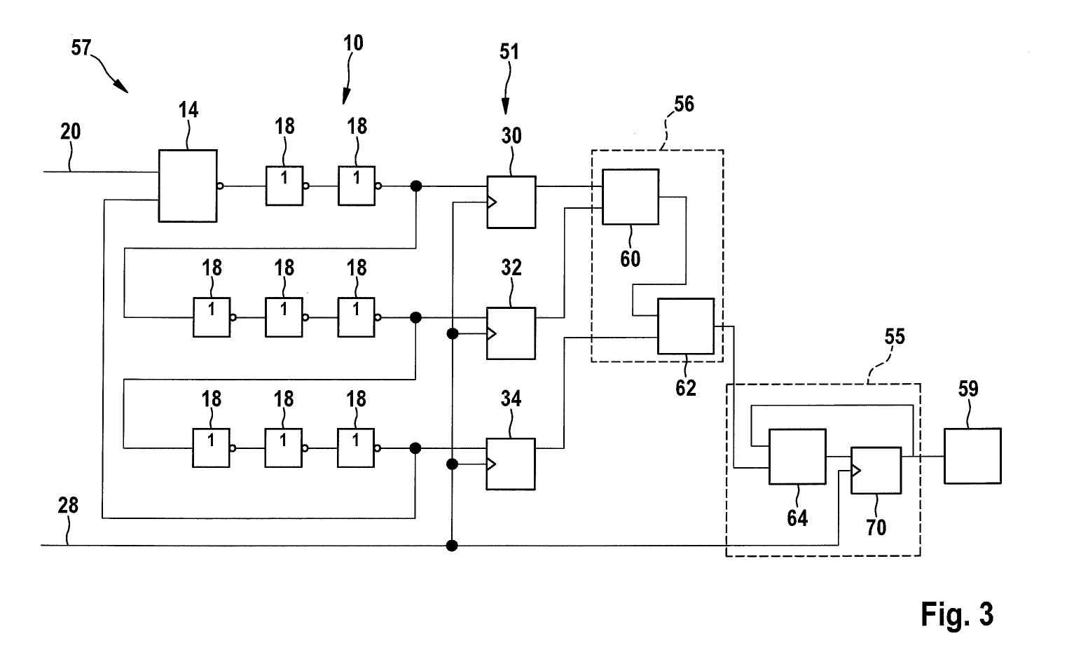

FIG. 3 shows a further system for compression.

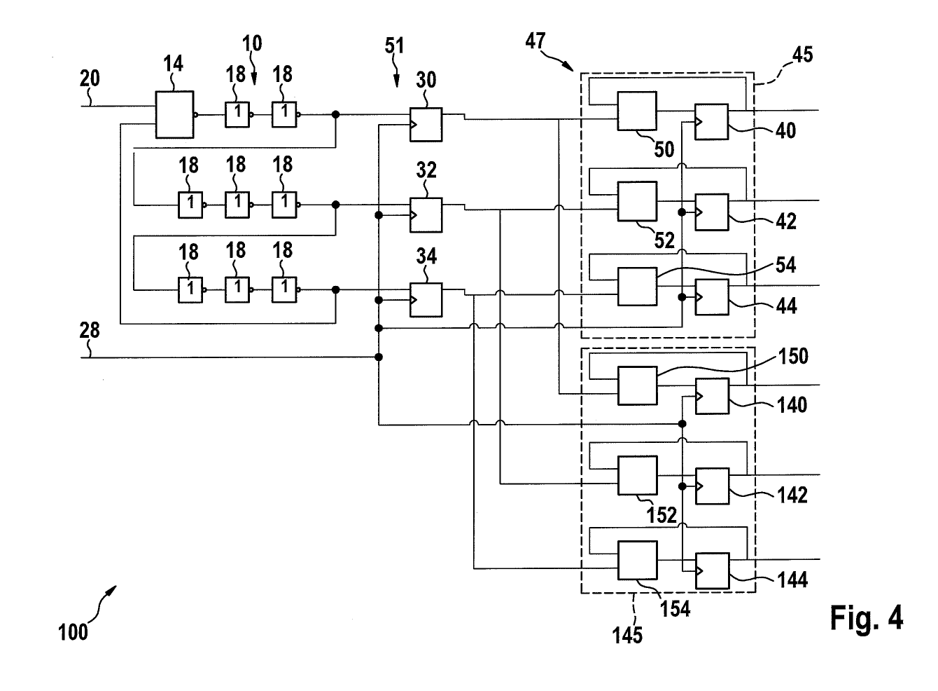

FIG. 4 shows an embodiment of the system for carrying out the presented method.

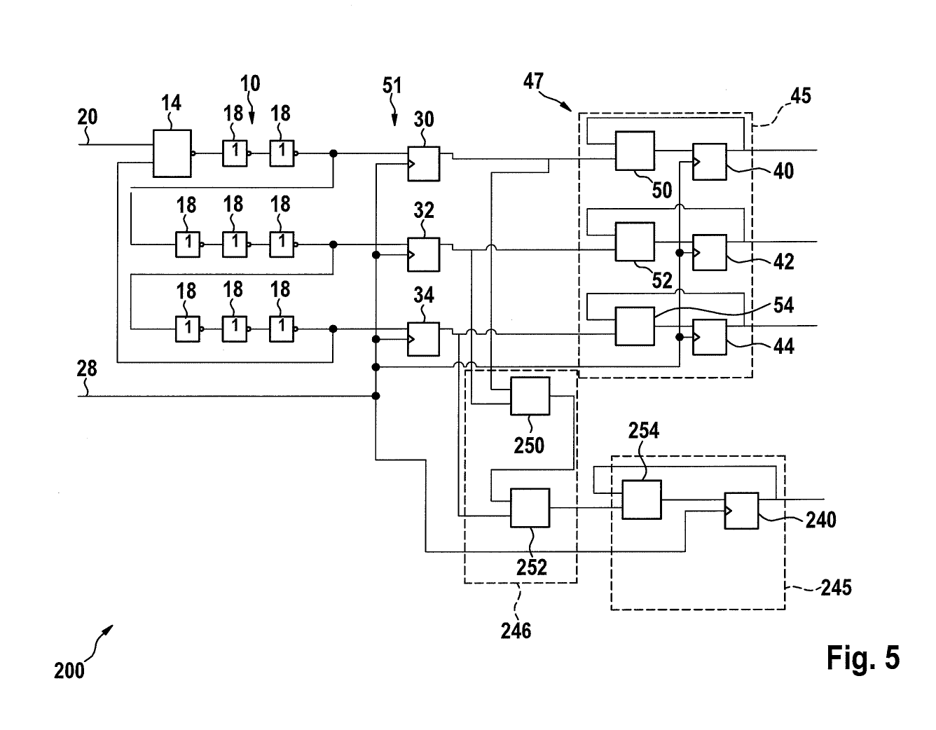

FIG. 5 shows a further embodiment of the system for carrying out the presented method.

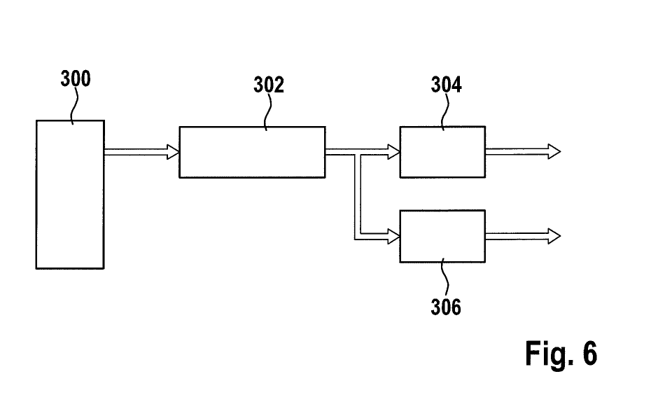

FIG. 6 shows, in a greatly simplified representation, an embodiment of a circuit system.

### DETAILED DESCRIPTION

The present invention is schematically shown on the basis of specific embodiments in the drawings, and is explained in detail below with reference to the drawings.

FIG. 1 shows an embodiment of a ring oscillator as a random source, designated overall by reference character 10. Ring oscillator 10 has a NAND element 14 and eight inverters 18, and thus has nine inverting elements. Ring oscillator 10 thus has an odd number of inverting elements, and three pick-off or sampling points.

Ring oscillator 10 can be started and stopped with a first input 20. The sampling rate is specified via a second input 28. In addition, the drawing shows a first sampling point 22, a second sampling point 24, and a third sampling point 26. This means that, beginning from first sampling point 22, a sampling always takes place after an odd number of inverting elements. However, this is not necessarily required for the presented method.

First sampling point 22 is sampled using a first flip-flop 30, and sampling value s10 results. Second sampling point 24 is sampled using a second flip-flop 32, and sampling value s11 results. Third sampling point 26 is sampled using a third flip-flop 34, and sampling value s12 results. A further, fourth flip-flop 40 is assigned to first flip-flop 30. This fourth flip-flop performs a storage function and outputs the value s10′, which temporally follows value s10; i.e. s10 and s10′ are temporally successive sampling values of first sampling point 22. Correspondingly, second flip-flop 32 has assigned to it a fifth flip-flop 42, which outputs s11′, and a sixth flip-flop 44, which outputs s12′, is assigned to third flip-flop 34. Flip-flops 40, 42, and 44 are suitable for triggering metastable states of flip-flops 30, 32, and 34. Metastable states result from a switching over of the signal that takes place at input 28 during an edge at sampling point 22, 24, or 26.

Flip-flops 30, 32, and 34 then require a certain period of time to reach a stable end state. In the present example, this time is ensured in that the meanwhile stable value of flip-flops 30, 32, and 34 is not incorporated into flip-flops 40, 42, and 44 until the following active edge of the signal at input 28. Flip-flops 30, 32, 34, 40, 42, and 44 act as storage elements.

In principle, ring oscillator 10 can thus also be made up of for example nine inverters 18. One of these inverters 18 can be replaced by NAND element 14 in order to make it possible to retain ring oscillator 10. Alternatively, this NAND element 14 can also be replaced by a NOR element.

In the depicted embodiment, the values of ring oscillator 10 are stored simultaneously at three different inverters, in a respective flip-flop (FF) 30, 32, 34. These pick-offs should be distributed as uniformly as possible over the elements of ring oscillator 10. Therefore, for the case of nine inverting stages in ring oscillator 10, a pick-off or sampling point 22, 24, 26 should be provided after each three inverting elements. As already mentioned, however, this is not required for the presented method. It is also possible to provide a pick-off point after an even number of inverting elements.

The number of inverter stages in ring oscillator 10 determines the frequency of the oscillator, and should therefore be selected such that the flip-flops can store the respective signal value. If an oscillator frequency is used that is as high as possible, the probability is higher that the sampling will take place in the vicinity of an edge. Therefore, a number of inverters in the oscillator ring is selected that is as low as possible but that is great enough that the flip-flops are capable of operation at the achieved frequency. For a 180 nm technology, as a simulation a frequency of approximately 1 GHz was determined for ring oscillator 102 having nine inverters 18. The flip-flops can store the signal values at this frequency, as was confirmed.

The presented method can be carried out with the ring oscillator 10 corresponding to FIG. 1, which has an odd number of inverting elements, values being picked off at at least one sampling point of ring oscillator 10.

For ring oscillator 10, a correlation to the system clock, and thus to the sampling clock pulse obtained therefrom, can be determined. For this purpose, the comparison takes place as to whether the three bit values at the output of flip-flops 30, 32, and 34 are identical with those at the output of flip-flops 40, 42, and 44. Not all correlations can be determined by the comparison of s10, s11, s12 with s10′, s11′, s12′, even if the divisor value of the frequency divider is divisible by the number of inverting elements in the oscillator ring. It can happen that in each case after an arbitrary, possibly constant number of samplings, sampling always takes place at the same position in the oscillator cycle. If this number is not at the same time a divisor of the number of inverting elements in the oscillator, then the comparison currently described does not provide any indication of the existing correlation. It is then nonetheless possible to determine the correlation if all samples are compared to the current sampling. However, this is very costly.

For the ring oscillator according to FIG. 1, having for example nine inverters and three sampling points, the bit values stored at the sampling points as a rule change at least one bit value after a not-too-high number of samplings. A high number of successive equal bit values is recognized by counting warnings, and either an error is signaled or action is taken to influence the frequency of the oscillator.

For the ring oscillator according to FIG. 1, nine inverters and three sampling points are thus provided. In a first flip-flop connected to a sampling point of the oscillator, the states of the oscillator at the sampling point are stored. The second series of subsequent flip-flops is suitable for compensating metastable states in each of the first flip-flops. Such metastable states can arise in that the sampling clock becomes active during a state transition of the oscillator. The new storing of the state in the respective second flip-flop ensures that the state of the first flip-flop can oscillate over a period of the sample clock before this stable value is incorporated into the second flip-flop. If this structure is realized in a balanced manner, a desired behavior can then be achieved. The balancing however requires the use of special gates, namely inverters and flip-flops, that have a sufficiently uniform driver strength for the low-high and high-low edge, including for the internal nodes of the flip-flops. In addition, the layout has to be designed such that equal load capacitances are present for all pick-off points of the ring oscillator and their controlling nodes. In a balanced circuit according to FIG. 1, for example, the bit occupations 000 and 111 do not occur.

In a test chip presently under consideration, gates of a digital standard library were used. The ring oscillator can in addition have another pick-off point to which an amplifier is connected for the purpose of frequency measurement. Given measurements at this test chip, it was determined that the predicted distribution of the output bits was not correct. Both the values 000 and 111 occur. In addition, it was determined that the distribution of the remaining six states occurs in a manner not uniformly distributed, even when the sampling frequencies are varied. In particular, it was determined that in the test chip under consideration the number of samplings with the decimal values of the three sampling bits 3, 5, and 6 is significantly higher than those of 1, 2, and 4.

It was recognized that, when a post-processing is carried out in which the three output bits are linked using XOR, the 0 occurs much more often as a result than the 1. This imbalance (bias) in the 0-1 distribution should in fact be avoided, or at least corrected by a suitable post-processing. The thus obtained sequence of random bits is also referred to as an internal random sequence, which should have a uniform distribution of 0 and 1; see: Killmann, W., Schindler, W.,: AIS 31, Version 1, BSI, 25 Sep. 2001. If such a distribution of the internal random sequences is not possible, a complex structure is also admissible as post-processing, which generates random numbers from the internal random sequences. Because such structures may cause distortion that merely conceals the true, namely inadequate, behavior, a particular testability is also required after post-processing if the test of the internal random sequences was not successful. The certification mode required for this is described for example in DE 60 2004 011 081 T2. If such a test is passed, then the post-processing structure is regarded as suitable and the tests regarding the uniform distribution of 0 and 1 can also be shown at the output data of this complex post-processing structure.

The described method achieves the advantage of saving such a structure and in particular the certification mode. This is possible if the compression is carried out in such a way that the internal states of the post-processing circuit are reset after each output of a random bit. For this purpose, for example a simple compression is already carried out bit-by-bit before the individual bits are further processed. In the circuit of FIG. 2, a compression is proposed having a respective serial XOR before the value is stored in the second flip-flop. Storage elements 40, 42, and 44 of FIG. 2 are reset after each output to output unit 49. The “stateless” compression achieved in this way saves an additional certification mode.

FIG. 2 shows a system 47 having ring oscillator 10 from FIG. 1, a first XOR element 50, second XOR element 52, and third XOR element 54 being provided. These are used to carry out a bit-by-bit compression. The compressed values are available in second flip-flops 40, 42, and 44 after the termination of the compression. Their outputs are designated s10″, s11″, and s12″ (s1i′). These values are stored in output unit 49 and can also be checked there with regard to their distribution. XOR elements 50, 52, and 54 together with flip-flops 40, 42, 44 represent a processing unit 45 for the compression. Flip-flops 30, 32, and 34 act as storage elements whose outputs s10, s11, and s12 are post-processed, and represent a sampling unit 51.

After the sampling values of ring oscillator 10 are stored in a respective first flip-flop 30, 32, or 34, each individual bit s1i is XOR-linked, in a second stage, to the output of one of the second flip-flops 40, 42, or 44. In this way, a compression is achieved by causing the value of s1i to enter into the value of s1i′ for example n times.

At the same time, second flip-flop 40, 42, or 44 performs the task of taking into account metastable states in first flip-flop 30, 32, or 34, in that an entire sampling period is available for the establishment of this labile state. The degree of compression n should be selected large enough that the prescribed 0-1 distribution is achieved for each individual bit. In the sequence, the three random bits can be combined to form a single random bit. For this purpose, the three bits can be linked to one another antivalently, i.e. using XOR, or can also enter into a post-processing structure in parallel fashion. This post-processing structure can also be a PRNG that generates pseudo-random number sequences from the random numbers. If the original random number (standardly also referred to as the seed) is not known, the output of the PRNG is then also not predictable. Here, it is advantageous if the compression factor n is odd, if possible. As a result, n successive zeros yield a different bit value (0) than do n successive ones (1). In addition, it can be advantageous for n to be a prime number, because the compression then cannot be put together from a sum of a plurality of compressions.

The bit-by-bit serial XOR linkage on the one hand achieves the goal of removing non-uniform 0-1 distributions, and on the other hand enriches the entropy (of the random value) through the compression.

The improved distribution of 0 and 1 is determined by the magnitude of compression factor n. As a rule, a better uniform distribution results for larger n.

If the entropy for a single sampling period is equal to x, then for two samplings it is equal to 2*x. However, when the sampling period is doubled only a value of 1.414*x is obtained for the entropy in the same time period.

It is therefore more advantageous to select the sampling period to be not too long, and for this purpose to compress a plurality of sampling values, i.e. an n as high as possible. On the other hand, however, it can also be disadvantageous to compress too many sampling values with the serial XOR according to FIG. 2, because the entropy values can then mutually compensate one another. It is to be noted that an even number of entropy values “1” cancel one another out in the XOR compression. Experimental trials have shown that a compromise for the sampling values can be found with n between some 10 and some 100, up to a few 1000, values. In this case, the sampling frequencies are between 300 kHz and 12.5 MHz at an oscillator frequency of close to 1 GHz. The internal random sequences obtained in this way already passed the generally recognized standard statistical tests without requiring an additional post-processing.

It can therefore be claimed that a ring oscillator is constructed from digital standard elements, namely inverters or inverting elements and a NAND or NOR in order to retain the oscillator. In addition, it can be claimed that the digital standard design flow can be used for the design of the ring oscillator and the sampling flip-flops, because no manual intervention in the layout is necessary. In the present test chip, both the digital elements, in their driver action with regard to the edges, and also the capacitive loading of the ring oscillator due to the connection of an amplifier for frequency measurement, can be distributed in very different ways.

After the XOR compression, with suitable parameters, all of this has no disadvantageous influence on the statistical tests. The conditions of the tests can be met without additional complex structures for post-processing. For this purpose, the three compressed signals can be linked to one another by XOR (anti-valence) or some other linear function, e.g. equivalence, and this output signal can be further processed.

In a further embodiment, the output bits of the three sampling flip-flops can also be linearly linked with one another already before the XOR compression, for example using XORs (anti-valence) or also equivalence operators (XNOR).

In addition, a device 49 is provided for outputting and for checking the compressed signal values with regard to their distribution. In this device 49, for example the above-mentioned XOR linkage of the three compressed bits can also take place, an output bit of the random generator being generated in each case.

FIG. 3 shows a random generator 57 as a possible embodiment of the presented system having ring oscillator 10 and having a first XOR element 60 with output s01, a second XOR element 62 having output s012, and a third XOR element 64. In addition, a second flip-flop 70 is provided that outputs s012″. XOR elements 60, 62 form a linkage unit 56 for linking the three output signals to form a combined, uncompressed output signal. XOR element 64 and flip-flop 70 form a processing unit 55 for the compression. The number of bits nᵢ that come from XOR element 62 and are processed to form a random bit agrees with compression factor nᵢ. In addition, a device 59 is shown for testing a distribution, for storing the random bits, and for outputting.

The advantage of this embodiment is that it is then necessary to compress only one signal using XOR. However, it is to be noted that the properties of the circuit can no longer be assessed as well as they can when the three compressed signals are present. Due to the linearity of the XOR operations, the output signals of FIG. 2 and FIG. 3 are equal if the three output signals of FIG. 2, s10″, s11″, and s12″, are linked with XOR to form a signal s012″:

s012″=s10(0)⊕S10(1)⊕s10(2) . . . ⊕s10(n−1)

With

s010″=s10(0)⊕s10(1)⊕s10(2) . . . ⊕s10(n−1)

s011″=s11(0)⊕s11(1)⊕s11(2) . . . ⊕s11(n−1)

s012″=s12(0)⊕s12(1)⊕s12(2) . . . ⊕s12(n−1)

the following results from the present equation:

s012″=s10(0)⊕s10(1) . . . ⊕s10(n−1)⊕s11(0)⊕s11(1) . . . ⊕s11(n−1)⊕s12(0)⊕s12(1) . . . ⊕s12(n−1).

and according to FIG. 3:

s012=s10⊕s11⊕s12

and

s012″=s012(0)⊕s012(1)⊕s012(2) . . . ⊕s012(n−1)

there results from the present equation

s012″=s10(0)⊕s11(0)⊕s12(0)⊕s10(1)⊕s11(1)⊕s12(1) . . . ⊕s10(n−1)⊕s11(n−1)⊕s12(n−1).

Due to the commutative law of anti-valence, according to which the operands can be exchanged arbitrarily, the two equations for s012″ are identical.

A TRNG can be realized as IP (intellectual property) using the presented method. A product is designated as IP that provides a circuit description together with tests in such a way that a client of this product is able to realize the circuit on a chip using their own technology. Due to the extremely low circuit outlay, namely about 200 gate equivalents, it is practically usable anywhere where randomness plays a role.

In addition, the present invention such TRNGs can be used in sensor evaluations for protection against manipulation, or in security applications in connections to the Internet.

In addition, a circuit system is presented having at least one ring oscillator that includes an annular interconnection of an odd number of inverting elements, this ring oscillator being sampled at one or more sampling points or positions, and the sampled values being simultaneously stored in storage elements with a sampling clock pulse, the outputs of the storage elements being connected to an input of a linear linkage element.

In addition, a circuit system is presented having a random source having at least one digital output signal having a bit width of at least one bit and a circuit for compressing this output signal, the circuit carrying out a block-by-block XOR linkage of n bits, from each bit of the output signal to a respective bit of a compressed output signal, and the sequence formed in this way of the compressed signal values is checked with regard to its distribution. The block-by-block XOR linkage means that n successive bits are XOR-linked to one another serially. The checking of the distribution can be carried out for each individual output bit according to FIG. 2, or for the combined output bit according to FIG. 3, for example in such a way that the number of zeros and ones in this bit sequence is counted, and these count values are compared to one another. This comparison can for example take place through difference formation of the two count values, it being tested whether the difference exceeds a specified maximum value. The comparison can also be made with fixed limits.

The circuit system can be distinguished in that as a function of the result of the check of the distribution, an action is taken to influence compression factor n.

In addition, the random source can contain at least one ring oscillator made up of an annular interconnection of an odd number of inverting elements, this ring oscillator being sampled with a clock pulse at at least one position.

As a function of the result of the check of the distribution, action can be taken to influence the frequency of the sampling clock pulse.

In addition, as a function of the result of the test of the distribution, action can be taken to influence the frequency of the ring oscillator, such as for example through the number of inverting elements in the ring oscillator, or through a modification of the operating conditions of the oscillator (operating voltage, temperature).

The output signal of the random source can be made up of a plurality of bits, and at least two of these bits can be combined by a linear linkage to form one bit that is correspondingly compressed through block-by-block XOR linkage of n bits, and the compressed bit sequence can be checked with regard to its distribution.

The output signal of the random source can be made up of at least k bits that are not linked to one another, and each of these k bits is provided with a circuit for processing the output signal, and the correspondingly compressed k bits form an occupancy having 2^{k} possible values, and the occurrence of all of these 2^{k} possible values is counted in separate counters, and the frequency of all these occupancies are compared to one another.

A check of the distribution can for example be achieved by counting the occurrence of the bit value 0 and bit value 1 in separate counters for m compressed output bits, and by carrying out the comparison through difference formation of these count values, and comparison of the difference as to whether it exceeds a specified limit.

In the embodiments shown in FIGS. 1 through 3, a simple compression using XOR is proposed; here the degree of compression n should be selected large enough that the prescribed 0-1 distribution is achieved for each individual bit, as can be seen in FIG. 2. After an XOR linkage of the compressed 3 bits, 1 bit random value is obtained having a uniform 0-1 distribution and maximum entropy. Typically, here the uncompressed 3 bits contain more entropy than can then be shown in the one compressed bit. Thus, entropy is destroyed. As is shown in FIG. 3, the three oscillator sampling bits, the so-called raw data, can also be XOR-linked to one another before the compression takes place with a single XOR.

In contrast, however, the single compression of the 3 bits has the advantage that the properties of the resulting bits can be better assessed.

FIGS. 4 and 5 show circuits according to the present invention that carry out a multiple compression of the same sampling bits s0, s1, and s2 using different compression factors. Here it is to be noted that compressed the bits, combined for example by XOR to form a single bit (s10″, s11″, and s12″, or s20″, s21″, and s22″), are each compressed using the same compression factor.

FIG. 4 shows ring oscillator 10 from FIG. 1 having sampling unit 51 from FIGS. 2 and 3, as well as processing unit 45 from FIG. 2, a second sampling unit 151, and a second processing unit 145, and thus shows a system for carrying out the method that is designated overall by reference character 100. The values sampled by sampling unit 51 are additionally supplied to second processing unit 145, which includes a first XOR element 150, a second XOR element 152, and a third XOR element 154. These processed values are in turn supplied to flip-flops 140, 142, and 144, at whose outputs the compressed signal sequences s20″, s21″, and s22″ are present.

FIG. 5 shows ring oscillator 10 from FIG. 1 having sampling unit 51 from FIGS. 2 and 3, as well as processing unit 45 from FIG. 2, a second sampling unit 251, and a second processing unit 245, and thus a system for carrying out the method designated overall by reference character 200. The values sampled by sampling unit 51 are in addition supplied to a linkage unit 246 that includes XOR elements 250 and 252, and to second processing unit 245, which includes a third XOR element 254 and a flip-flop 240. In its design, processing unit 245 corresponds to processing unit 55 from FIG. 3. At the output of flip-flop 240, compressed signal sequence s2″ is present.

If the compression factor for s10″, s11″, and s12″ is equal to n, and for s20″, s21″, and s22″ is equal to m, then for n*m sampling clock pulses, m+n result bits are present. If s1″=s10″⊕s11″⊕s12″ and s2″=s20″⊕s21″ s22″, the m bits are s1″ and the n bits are s2″. Here it is important that n and m be relative primes, and most preferably prime numbers.

If the entropy of the three sampling bits s0, s1, and s2 together is equal to H₀, then for n*m samplings the entropy value H2=n*m*H₀ is present. The m bits s1″ and n bits s2″ have the full entropy value (and thus adequate random properties) only if H2≧m+n. In order to proceed with certainty, in this “un-equation” the equality sign is preferably not used; rather, better values are chosen, so that H₂≧ε(m+n), where ε>1. With the sampling frequency f_{A}, the data rate of the TRNG becomes

D_{TRNG}_{_{—}}₂=f_{A}*(m+n)/(m*n)bit/sec

With the use of only one compression, after the same number of samplings only m bit values are present when compression takes place with the factor n, and the data rate thus becomes

D_{TRNG}_{_{—}}₁=f_{A}*(m)/(m*n)=f_{A}/n bit/sec

In general, in a generalization of the method according to FIG. 4, given x compressions n₀, n₁, n₂, . . . , nₓ₋₁ the value

D_{TRNG}_{_{—}}ₓ=f_{A}*(Σ(πnₖ/nᵢ)/πnᵢ) bit/sec (=0 . . . x−1, k=0 . . . x−1)

is obtained.

Here, however, care must be taken to ensure that the entropy for these multiple compressions is adequate given πnᵢ sampling values of the oscillator:

$${H}_{x} = {\prod }_{i = 0}^{x - 1} {n}_{i} {H}_{0} > {\sum }_{i = 0}^{x - 1} \frac{{\prod }_{k = 0}^{x - 1} {n}_{k}}{{n}_{i}} oder {H}_{0} > δ \frac{{\sum }_{l = 0}^{x - 1} \frac{{\prod }_{k = 0}^{x - 1} }{{n}_{i}} {n}_{k}}{{\prod }_{i = 0}^{x - 1} {n}_{i}} \qquad ( 1 )$$

Here it is to be noted that for the entropy estimation of the TRNG result bits, this equation is only a necessary condition. With exclusively prime numbers, or at least relatively prime nᵢ values, and ε>1, however, the certainty is increased that all random bits generated in this way are independent of one another (see also the remarks below).

In order to calculate the entropy, first the jitter of the oscillator is determined, taking into account the sampling of this oscillator through the period duration ΔT in which the jitter builds up.

The jitter can be calculated using

$${σ}_{Δ T} = \sqrt{\frac{8}{3 η}} \sqrt{\frac{{V}_{DD}}{{V}_{Char}} \frac{{k}_{B} T}{P}} \sqrt{Δ T} \qquad ( 2 )$$

Here, for short-channel transistors the following holds:

$${V}_{Char} = \frac{3}{8} ( \frac{{V}_{DD}}{2} - {V}_{T} ) \qquad ( 3 )$$

and in addition:
k_{B}: Boltzmann constant (1.38*10⁻²³ J/K)
η: technology constant of the switching elements used (typically ≈1)
V_{DD}: operating voltage of the oscillator (e.g. 1.8 V)
T: temperature (e.g. 298 K)
P: power consumption of the oscillator
V_{T}: threshold voltage of the transistors in the oscillator
ΔT: time span between two samplings
σ_{ΔT}: standard deviation of the jitter

For the calculation of the entropy, it is assumed that in a range of ±1.299σ_{ΔT} around an oscillator edge the entropy value is 0.5, and outside this region the value 0 is assumed. If it is further assumed that the samplings are distributed uniformly over the oscillator period if the oscillator frequency and the sampling frequency do not oscillate with one another, then, corresponding to the portion of the region of ±1.299 σ_{ΔT} and the corresponding number of edges to be taken into account relative to the oscillator period, one obtains an entropy value H₀ if the samplings are distributed uniformly over the oscillator period.

H₀=f₀*1.299*σ*2*0.5*6 (4)

In a sample case, there is the value H₀ for an oscillator having 852 MHz oscillating frequency. Given a sampling at 301.2 kHz, the jitter is 52,465 ps, and thus the entropy is 0.34839.

At a sampling rate of 3125 kHz, a jitter is obtained of 16,288 ps, and thus H₀=0.102334.

Given a compression factor n=41, the statistical tests are successful and the test is therefore positive. Consequently there results a TRNG entropy value H₁=41*0, 102334=4, 196 bits per 41 samples (compressed to one bit, which can only have an entropy of 1), and a TRNG bit rate of 76.2 kbit/s.

With an additional compression unit having compression factor 43, the following is obtained:

H₀=0.102334>(41+43)/41*43)=0.0476 (ε=2.148) and a bit rate of 148.9 kbit/s.

With an additional compression unit having compression factor 47, the following is obtained:

H₀=0.102334>(43*47+41*47+41*43)/(41*43*47)=5711/82861=0.068923 (ε=1.48476), bit rate=215.4 kbit/s.

The check of the distribution does not have to be carried out for all compression units. It is sufficient to check the compression unit having the lowest compression factor. As measurements on a test chip have shown, all other greater compression factors then also meet the conditions if the decision conditions have been selected to be strict enough.

A proof of the statistical independence of the result bits from one another still has to be shown. For this purpose, an experimental proof may be used, or a theoretical consideration, as described in the publication of Markus Dichtl (Siemens AG): Bad and Good Ways of Post-Processing Biased Physical Random Numbers; see: Biryukov. A. (ed.), FSE 2007, LNCS, vol. 4593, pp. 127-152, Springer, Heidelberg 2007.

The following considerations, leading one to expect independence, contribute to such a proof: if a simple compression, for example of 41 samples at 3 bits, as in the above example, is present, then all of the entropy cannot be projected onto the resulting result bit. Entropy is destroyed here. Without limitation of generality, it can be assumed that the entropy bits are distributed uniformly in the sample space if the sample space is taken to be the totality of all sampled bits. Here, an entropy bit is a bit that does not always supply the same value under otherwise identical conditions. Because the assumptions for the entropy estimation also proceed from the assumption that the ring oscillator is sampled uniformly in its period, this thesis is to be regarded as correct. An entropy bit having value 1 is to be designated as dominant. The dominant entropy bits are also consequently distributed uniformly in the sample space, if the sample space contains the estimated value of entropy. It is further assumed that the distribution of the dominant entropy bits is not systematic; otherwise, one would have to assume correlations of the ring oscillator with the sampling clock pulse. Such correlations have to be recognized using suitable monitoring measures, and prevented.

If a first sample of 41×3 bits contains an even number of dominant entropy bits, the resulting random bit has a determinate value p. If the number of dominant entropy bits is odd, then the resulting random bit has the inverse value /p. Thus, the question whether the value of the random bit has the value p or /p is a function only of whether the selected sample contains an even or odd number of dominant entropy bits. If an additional compression unit is now selected having a different compression factor, e.g. 43, then the samples having 43×3 bits typically do not contain the same number of dominant entropy bits.

The first 43×3 sample contains at least the same number of dominant entropy bits as the sample 41×3, if the removal of the sample in the sample space starts at the same position. However, the 2×3 additional bits can also contain further dominant entropy bits that change the random value. Because a uniform, but not systematic, configuration of the dominant random bits is assumed, these are not predictable, and in particular vary over the course of multiple samples. The second 41×3 sample then contains these additional bits under consideration, while they are absent in the second 43×3 sample. Instead, 4×3 bits occur in the second 43×3 sample. Thus, the two samples differ in 6×3 bits, and therefore have a still greater potential for changes in the number of dominant bits in the sample. For the third samples, there are further shifts in the sample space that result in non-predictable contents with dominant random bits. In the further samples, there result further shifts that, only after 41×43 samples, return to the initial state, in which the first sample bits of the two compression units are equal. This is ensured because the two compression factors are relative primes, or are prime numbers. However, even in this case the same conditions as at the beginning are not present, because the distribution of the dominant random bits for this new segment of the sample space is not the same as at the beginning Therefore, there is no state in which one can make an inference from the random bit of the one compression unit to a random bit of the other compression unit. This would be possible only if a too-small number of dominant entropy bits was present. However, this would violate the necessary condition for observing entropy. Therefore, it is always important to estimate the overall portion of entropy of the uncompressed sample bits, and to determine the thus possible bit rate of the TRNG.

No functional relation of the TRNG bits from different compression units is then to be expected.

FIG. 6 shows a schematic representation of the design of the proposed solution. The drawing shows a random source 300, a sampling unit 302, and two processing units 304 and 306. Random source 300 is picked off by sampling unit 302, and this sampling unit distributes the data to the two processing units 304, 306. Processing units 304, 306 carry out a compression with different compression factors. The output of at least one processing unit 304 or 306 can be checked. Typically, for this purpose the processing unit 304 or 306 having the smaller compression factor is selected. In this embodiment, processing units 304, 306 carry out a compression. However, other processings are also possible.

It is to be noted that the required circuit outlay is very low, and digital standard methods can be used.

Due to the extremely low circuit outlay, approximately 200 gate equivalents, the method can in practice be used anywhere where randomness plays a role, such as for example Car2x, smart phone IPs for secure applications (online banking, communication of confidential data), key generation, side channel robustness.

In addition, a circuit system is described that includes at least one random source and at least one sampling unit that is connected to the random source. Here, it is provided that the sampling unit is connected to at least two processing units that differently process data from the sampling unit, and that in an embodiment the output of at least one processing unit is checked with regard to the distribution of the possible output occupancies.

In addition, a circuit system is presented in which the random source is a ring oscillator and the sampling unit picks off signal values at particular sampling points of the ring oscillator, and stores these, with the sampling clock pulse, in storage elements of the sampling unit as random values, and these random values are the data that are processed in the processing units. In addition, it can be provided that the data from the sampling unit are made up of at least one bit, and are processed in at least one processing unit i in such a way that each bit of the output signal, for a fixed number of nᵢ sampling clock pulses, is serially XOR-linked to the preceding/following bits, and the compressed bits generated in this way are outputted.

Moreover, it can be provided that the data from the sampling unit are made up of a plurality of bits and are processed in at least one processing unit k in such a way that all of these bits are XOR-linked to one another, and each result bit obtained in this way, for a fixed number of nₖ sampling clock pulses, is serially XOR-linked to the preceding/following result bits, and the compressed result bit generated in this way is outputted.

The number nᵢ, nₖ can be compression factors that are different for each processing unit and are prime relative to one another.

In addition, it can be provided that the outputs of the processing unit having the smallest compression factor are checked by counting the frequency of all possible occupancy values in the output sequence, and comparing them to one another or relative to a fixed comparison value.

What is claimed is:

1. A method for generating an output of a random source of a random generator, comprising:
outputting at least two output signals having a bit width of at least one bit;
sampling the random source by at least one sampling unit, so that in each case an output signal is generated; and
processing an output signal of the sampling unit by at least two processing units that process differently.

2. The method as recited in claim 1, wherein in each processing unit a compression is carried out, a block-by-block linear linkage of nᵢ successive bits of the output signal being carried out in the context of the compression, nᵢ being a compression factor of processing unit i, and nᵢ of the at least two processing units being different from one another, whereby at least two compressed output signals are generated, each including a sequence of compressed signal values.

3. The method as recited in claim 2, wherein the nᵢ of the at least two processing units are relatively prime.

4. The method as recited in claim 2, wherein the nᵢ of the at least two processing units are prime numbers.

5. The method as recited in claim 2, wherein a sequence of compressed signal values of at least one processing unit is checked with regard to its distribution.

6. The method as recited in claim 1, wherein:
the random source is a ring oscillator,
the at least one sampling unit picks off signal values at particular sampling points of the ring oscillator, and stores the picked off signal values with a sampling clock pulse in storage elements of the sampling unit as random values, and
the random values are the data that are processed in the processing units.

7. The method as recited in claim 1, wherein data from the at least one sampling unit is made up of at least one bit and is processed in at least one processing unit i in such a way that each bit of the output signal, for a fixed number of nᵢ sampling clock pulses, is XOR-linked serially with the preceding/following bits, and the compressed bits generated in this way are outputted.

8. The method as recited in claim 1, in which data from the sampling unit is made up of a plurality of bits, and are processed in at least one processing unit k in such a way that all of these bits are XOR-linked to one another, and each result bit obtained in this way, for a fixed number of nₖ sampling clock pulses, is serially XOR-linked with the preceding/following result bits, and the compressed result bit generated in this way is outputted.

9. The method as recited in claim 1, in which outputs of the processing unit having the smallest compression factor are checked by counting a frequency of all possible occupancy values in the output sequence, and comparing them to one another or to a fixed comparison value.

10. A system for generating an output of a random source of a random generator, comprising:
an arrangement for outputting at least two output signals having a bit width of at least one bit;
a sampling unit for sampling the random source, so that in each case an output signal is produced; and
at least two processing units that process differently and that process the output signals of the sampling unit.

11. The system as recited in claim 10, wherein in each processing unit a compression is carried out, a block-by-block linear linkage of nᵢ successive bits of the output signal being carried out in the context of the compression, nᵢ being a compression factor of processing unit i, and nᵢ of the at least two processing units being different from one another, whereby at least two compressed output signals are generated, each including a sequence of compressed signal values.

12. The system as recited in claim 11, wherein the nᵢ of the at least two processing units are relatively prime.

13. The system as recited in claim 11, wherein the nᵢ of the at least two processing units are prime numbers.

14. The system as recited in claim 11, further comprising a device for checking a sequence of compressed signal values with regard to its distribution.

15. The system as recited in claim 10, wherein the random source is a ring oscillator.
